(19) United States
(12) Patent Application Publication
(10) Pub. No.: US 2023/0140152 A1
(43) Pub. Date: May 4, 2023

(54) IMAGE PROCESSING APPARATUS, IMAGE CAPTURING APPARATUS, CONTROL METHOD, AND STORAGE MEDIUM

(71) Applicant: CANON KABUSHIKI KAISHA, Tokyo (JP)

(72) Inventor: Masanori Fukada, Tokyo (JP)

(21) Appl. No.: 18/050,936

(22) Filed: Oct. 28, 2022

(30) Foreign Application Priority Data
Nov. 2, 2021 (JP) 2021-179729

(51) Int. Cl. G06V 10/25; G06T 5/50; G06T 7/50; G06T 7/62; G06T 7/70

(52) U.S. Cl. CPC G06V 10/25; G06T 5/50; G06T 7/50; G06T 7/62; G06T 7/70; G06T 2207/10144; G06T 2207/20221

(57) ABSTRACT

An apparatus generates an image file with a structure including a first area storing a plurality of images and a second area storing metadata. The metadata includes first information for specifying a region in a reference image from among the plurality of images, and second information for specifying another image indicating a different representation of an object of a region specified by the first information. The apparatus sets a region for the reference image, selects, as the another image, an image different from the reference image from among the plurality of images with respect to the region, and generates the image file storing, in the first area, the first information configured for the region and the second information configured for the another image and storing, in the second area, the plurality of images.

### BACKGROUND OF THE DISCLOSURE

### Field of the Disclosure

The present disclosure relates to an image processing apparatus, an image capturing apparatus, a control method, and a storage medium and particularly relates to technology for generating an image file in which a region in a piece of image data is associated with a different piece of image data and stored.

### Description of the Related Art

A plurality of still images and moving images can be encoded and stored as a single image file in a known file format, and recently there are demands for an easy way of managing highly related image groups and the like such as image sequences from a burst of still images or the like. For example, with the file format known as High Efficiency Image File Format (HEIF), which is an international standard defined in ISO/IEC 23008-12, can store a still image encoded with a H.265 (HEVC), H.266 (VVC), AV1, or similar codec as a single image file. Regarding such a file format, the normative structure including metadata is defined, and the method of associating metadata with a stored image and the configuration of metadata in a specific format is defined. Also, by describing in the metadata region, a single image representation, such as a derived image, constituted by a plurality of still images can be stored as an image file.

With the file structure described in Japanese Patent Laid-Open No. 2020-127244, so that only a portion of the spatial portion of the moving image is extracted and played back, sub-video corresponding to tiles that divide all of the frames of the moving image and the full video relating to all of the frames as a composition are encapsulated.

However, with a file such as that described in Japanese Patent Laid-Open No. 2020-127244, because the sub-video displays a spatial portion of all of the frames, depending on the conditions in which all of the frame were captured, playback with a suitable representation may be unlikely due to black clipping or overexposure of the object in the space. In other words, the sub-video may not necessarily present an ideal representation of the region in a case in which a sub-video indicating a partial region is displayed and not the whole video.

### SUMMARY OF THE DISCLOSURE

The present disclosure was made in light of the circumstances described above and provides an image processing apparatus, an image capturing apparatus, a control method, and a storage medium in which an image with a different representation can be easily specified for a region in an image.

The present disclosure in its first aspect provides an image processing apparatus configured to generate an image file with a structure including a first storage area configured to store a plurality of pieces of image data and a second storage area configured to store metadata relating to the plurality of pieces of image data, the metadata including first specifying information for specifying a region in a reference image data from among the plurality of pieces of image data, and second specifying information for specifying another piece of image data indicating a different representation of an object of a region specified by the first specifying information, the image processing apparatus comprising: at least one processor configured to function as following units: an acquisition unit configured to acquire the plurality of pieces of image data; a first selection unit configured to select the reference image data from the plurality of pieces of image data acquired by the acquisition unit, a setting unit configured to set a region for the reference image data selected by the first selection unit; a second selection unit configured to select, as the another piece of image data, image data different from the reference image data from among the plurality of pieces of image data with respect to a region set by the setting unit; and a generation unit configured to generate the image file storing, in the first storage area, the first specifying information configured for a region set by the setting unit and the second specifying information configured for the another piece of image data selected by the second selection unit and storing, in the second storage area, the plurality of pieces of image data.

The present disclosure in its second aspect provides an image processing apparatus configured to generate an image file with a structure including a first storage area configured to store a plurality of pieces of image data and a second storage area configured to store metadata relating to the plurality of pieces of image data, the metadata including specifying information for specifying a region in at least one piece of image data from among the plurality of pieces of image data, the image processing apparatus comprising: at least one processor configured to function as following units: an acquisition unit configured to acquire the plurality of pieces of image data; a setting unit configured to set a region in the plurality of pieces of image data acquired by the acquisition unit; a selection unit configured to select, from among the plurality of pieces of image data, image data indicating a most appropriate representation of an object of each region in the plurality of pieces of image data set by the setting unit; and a generation unit configured to generate the image file configured for each piece of image data indicating the most appropriate representation selected by the selection unit and storing, in the first storage area, the specifying information for specifying a region indicating the most appropriate representation in the image data and storing, in the second storage area, the plurality of pieces of image data.

The present disclosure in its third aspect provides an image processing apparatus configured to playback an image file with a structure including a first storage area configured to store a plurality of pieces of image data and a second storage area configured to store metadata relating to the plurality of pieces of image data, the metadata including first specifying information for specifying a region in a reference image data from among the plurality of pieces of image data, and second specifying information for specifying another piece of image data indicating a different representation of an object of a region specified by the first specifying information, the image processing apparatus comprising: at least one processor configured to function as following units: an acquisition unit configured to acquire the image file for playback; a first presentation unit configured to present the reference image data stored in the image file for playback; and a second presentation unit configured to present the another piece of image data specified by the second specifying information in a case where an operation input to specify a region specified by the first specifying information is detected for the reference image data presented by the first presentation unit.

The present disclosure in its fourth aspect provides an image processing apparatus configured to generate an image file with a structure including a first storage area configured to store a plurality of pieces of image data and a second storage area configured to store metadata relating to the plurality of pieces of image data, the metadata including specifying information for specifying a region in at least one piece of image data from among the plurality of pieces of image data, the image processing apparatus comprising: at least one processor configured to function as following units: an acquisition unit configured to acquire the image file for playback; a first presentation unit configured to present any one of the plurality of pieces of image data stored in the image file for playback; and a second presentation unit configured to present image data including a region specified by the specifying information in a case where an operation input to specify a region specified by the specifying information is detected for image data presented by the first presentation unit.

Further features of the present disclosure will become apparent from the following description of exemplary embodiments (with reference to the attached drawings).

### BRIEF DESCRIPTION OF THE DRAWINGS

FIG. 1 is a block diagram illustrating an example of the functional configuration of an image capturing apparatus 100 according to embodiments and modified example of the present disclosure.

FIG. 2 is a diagram illustrating an example of the structure of a HEIF file according to the embodiments and modified example of the present disclosure.

FIG. 3 is a diagram illustrating an example of the definition of the data structure of region information data 242 according to the embodiments and modified example of the present disclosure.

FIGS. 4A, 4B and 4C are diagrams illustrating an example of the configuration of an image file according to the first embodiment of the present disclosure.

FIG. 5 is a diagram illustrating an example of the definition of the data structure of annotation information according to the embodiments and modified example of the present disclosure.

FIG. 6 is a flowchart illustrating an example of HEIF file generation processing according to the first embodiment of the present disclosure.

FIG. 7 is a flowchart illustrating an example of acquisition processing to acquire a series of image data according to the embodiments and modified example of the present disclosure.

FIG. 8 is a flowchart illustrating an example of HEIF file playback processing according to the embodiments of the present disclosure.

FIG. 9 is a flowchart illustrating an example of HEIF file generation processing according to the second embodiment of the present disclosure.

FIG. 10 is a flowchart illustrating an example of HEIF file generation processing according to the third embodiment of the present disclosure.

### DESCRIPTION OF THE EMBODIMENTS

Embodiments will be described in detail below with reference to the attached drawings. Note that the present disclosure according to the scope of the claims are not limited by the embodiments described below. A plurality of advantages of the embodiments are given. However, all of the plurality of advantages are not required for the present disclosure. Also, the plurality of advantages may be combined in a discretionary manner. Furthermore, in the attached drawings, the same or equivalent components are denoted with the same reference number, and redundant descriptions will be omitted.

The embodiment described hereinafter is an example of the present disclosure being applied to an example in which, as an image processing apparatus, an image capturing apparatus is used that is capable of generating an image file storing a series of image data with different exposures obtained via automatic exposure bracketing shooting (AE bracket shooting). However, the present disclosure can be applied to any device capable of acquiring a plurality of pieces of image data and generating an image file.

Also, in the present disclosure, “image data” is only required to be digital data indicating one or more images acquired via image capture and may include either a still image or a moving image or both. Furthermore, “image data” may be of a configuration in accordance with the file format of the image file generated and storing the image data and is not limited to encoded data.

### Image Capturing Apparatus Configuration

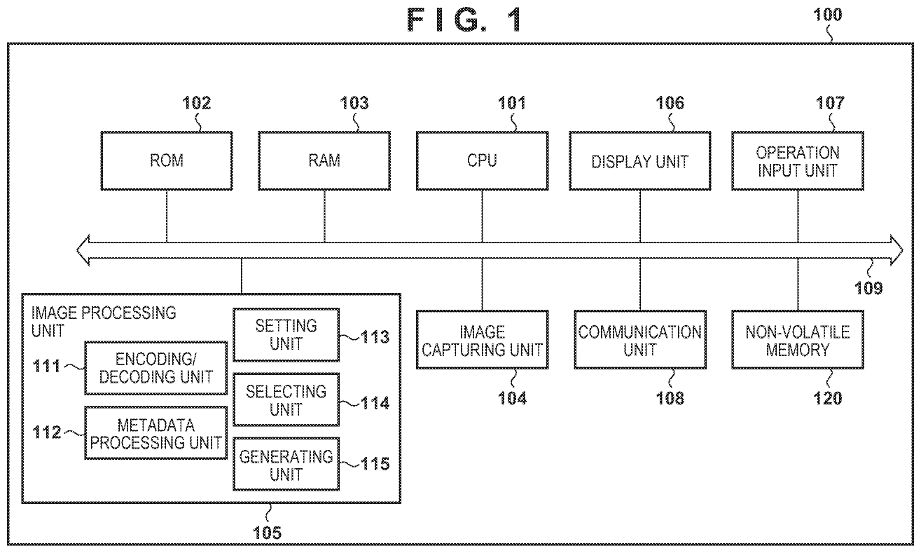

FIG. 1 is a block diagram illustrating a functional configuration of an image capturing apparatus according to the present embodiment. As illustrated, each functional configuration of an image capturing apparatus 100 is configured to transmit information via a system bus 109. Note that in the present embodiment described herein, the functions of the functional configurations are implemented via hardware including circuits and processors, but the present disclosure is not limited thereto. One or more of the functional configurations described hereinafter may be implemented via software by a program for implementing functions similar to the functional configurations. In this case, it is not necessary to isolate the illustrated functional configurations per unit on whether they are implemented via hardware or software.

A CPU 101 controls the operations of the functional configurations of the image capturing apparatus 100. Specifically, the CPU 101 reads an operation program (including a system program and an application program) for the functional configurations stored in a ROM 102 and controls the operations of the functional configurations by loading the program on a RAM 103 and executing the program.

The ROM 102 is a non-volatile storage apparatus capable of permanent information storage. The ROM 102 stores parameter information, display data, and the like required in the operations of the functional configurations in addition to the operation program of the functional configurations. The RAM 103 is a volatile storage apparatus capable of temporary information storage. The RAM 103 is used not only as a loading area for the operation program of the functional configurations but also as a storage area (output buffer) for temporarily storing data and the like output in the operations of the functional configurations. More specifically, the RAM 103 is also used as a data buffer in the image file generation processing described below and an output destination for temporarily storing image data and metadata for storing in the image file. It may also be used as a work area in the various types of image processing executed by an image processing unit 105 described below.

An image capturing unit 104 is an image sensor, such as a CMOS sensor, a CCD, or the like, for example. The image capturing unit 104 performs photoelectric conversion of an optical image formed on an imaging surface of the image sensor via a not-illustrated optical system. Also, the image capturing unit 104 includes a circuit for executing noise removal and gain processing on the output signal of the image sensor, further includes an A/D converter circuit or the like for converting an analog signal to a digital signal, and outputs a digital image signal (image data).

The image processing unit 105 executes various types of image processing on the image data. Image processing includes, for example, gamma conversion, color space conversion, and processing relating to development, such as white balance and exposure correction. Also, the image processing unit 105 may be capable of executing image data analysis processing and combining processing for combining two or more pieces of image data. Also, the image processing unit 105 executes image processing involving an encoding/decoding unit 111, a metadata processing unit 112, a setting unit 113, a selecting unit 114, and a generating unit 115 described below. To facilitate understanding of the present disclosure, the present embodiment has been described such that a single piece of hardware, the image processing unit 105, is used to execute the various types of image processing. However, the processing may be executed by hardware that is partially or completely different.

The encoding/decoding unit 111 is a codec for moving images and still images such as H.265 (HEVC), H.264 (AVC), H.266 (VVC), AV1, JPEG, or the like. The encoding/decoding unit 111 executes encoding and decoding processing on the still image data and moving image data handled by the image capturing apparatus 100.

The metadata processing unit 112 configures the metadata for storing in the image file generated by the image capturing apparatus 100 of the present embodiment. Specifically, the metadata processing unit 112 configures the metadata on the basis of an analysis result of image data stored in the image file and processing results of the setting unit 113 and the selecting unit 114 described below. The structure of the metadata configured by the metadata processing unit 112 is made compliant with the file format of the image file. Also, the metadata processing unit 112 analyzes the metadata stored in the image file upon playback of the image file generated by the image capturing apparatus 100.

Though the details will be described below, the image file generated by the image capturing apparatus 100 of the present embodiment stores a plurality of pieces of image data, and the metadata includes the information relating to these pieces of image data. Also, in the image file, a region is set in at least one piece of image data for storing, and, so that another piece of image data indicating a different representation of the object of the region can be referenced, information for associating the region and the other piece of image data is included in the metadata.

The setting unit 113 sets the region in the generated image file. The result of image analysis processing by the image processing unit 105 may be used in setting the region.

For the region set by the setting unit 113, the selecting unit 114 selects, from the plurality of pieces of image data for storing in the image file, another piece of image data for associating.

The generating unit 115 generates an image file storing the plurality of pieces of image data acquired as storage targets and metadata configured by the metadata processing unit 112.

A display unit 106 is, for example, a liquid crystal display (LCD) or the like integrally formed with the image capturing apparatus 100 or is a display apparatus detachably provided on the image capturing apparatus 100. The display unit 106 is used as an apparatus that displays a live view display during shooting and information such as various settings or a graphical user interface (GUI) or as an apparatus that displays images when the generated image file is played back.

An operation input unit 107 may be various user interfaces, such as an operation button, switch, or the like, provided on the image capturing apparatus 100. Also, in a mode in which the display unit 106 is a touch panel, the operation input unit 107 may include a touch panel sensor. When the operation input unit 107 detects that an operation has been input to the user interface, the operation input unit 107 outputs a control signal indicating this to the CPU 101.

A communication unit 108 is a communication interface with an external apparatus of the image capturing apparatus 100. The communication unit 108, for example, may be a network interface for connecting to the network and transmitting and receiving transmission frames. In this case, the communication unit 108, for example, may be a PHY and MAC (transmitting media control processing) capable of a wired LAN connection via the Ethernet (registered trademark). Alternatively, in a case in which the communication unit 108 is capable of connecting to a wireless LAN, the communication unit 108 may include a controller, an RF circuit, and an antenna for performing wireless LAN control based on IEEE 802.11a/b/g/n/ac/ax or the like.

A non-volatile memory 120, for example, is a non-volatile storage apparatus with a large storage capacity, such as an SD card, a CompactFlash (registered trademark) card, and the like. In the present embodiment, the non-volatile memory 120 may be used for storing a generated image file or an image file or the like acquired via the communication unit 108.

### Image File Generation

Image file generation using the image capturing apparatus 100 of the present embodiment will be described in detail below using the diagrams.

As described above, an image file generated by the image capturing apparatus 100 of the present embodiment can store a plurality of pieces of image data and includes information attached to the plurality of pieces of image data. In the modes described hereinafter, HEIF is used as the file format of the image file, and, to generate a compatible file (HEIF file), the functional configurations derive the required information and configure the metadata to attach. However, the present disclosure is not limited thereto, and the file format used for the generated image file may be a different moving image file format specified in MPEG or a format such as JPEG or the like, for example.

### HEIF File Structure

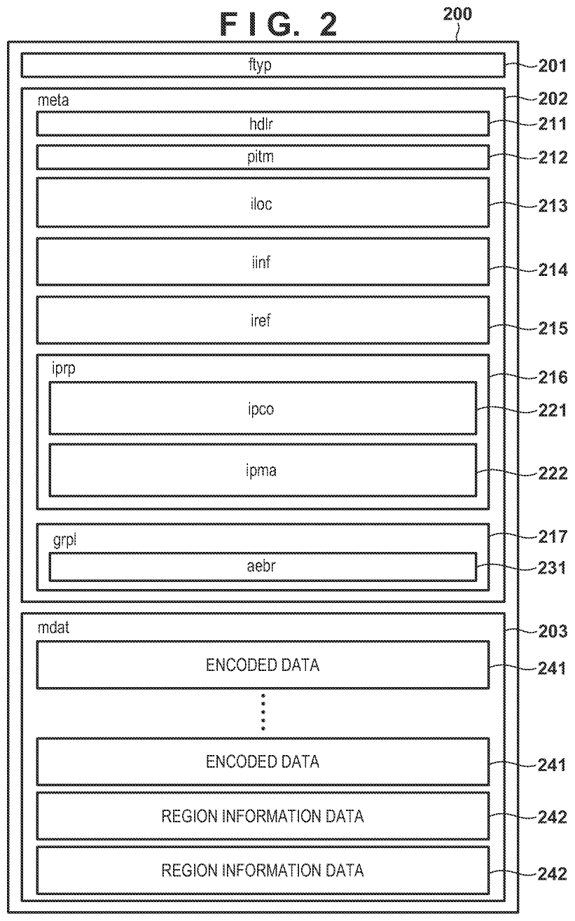

The file structure of a HEIF file will be described below using FIG. 2. As illustrated in FIG. 2, a HEIF file 200 is generally configured of the three boxes (storage areas) described below. The first box is FileTypeBox (ftyp) 201 and it stores brand names for the reader of the HEIF file 200 to identify the specifications of the file. In the case of a HEIF file, the ftyp box 201 stores “mifl” as a type value major-brand of a compliant brand definition and stores “heic” as a type value compatible-brands of a compatible brand definition. The second box is a MetaBox (meta) 202 and it stores untimed metadata describing various types of information for image data stored in the HEIF file 200. As illustrated, the meta box 202 separates various types of information relating to the image data into different boxes and stores them. This is described in detail below. The third box is a MediaDataBox (mdat) 203 and it stores a plurality of pieces of encoded data (image data) 241 as image item. In the present embodiment described here, the mdat box 203 is used as an area for storing the encoded data 241. However, for example, an “idat”, “imda”, or similar box structure may be used for this area. Note that hereinafter, the encoded data 241 stored in the mdat box 203 is referred to as the different terms “image item” and “image data” as appropriate.

A HandlerReferenceBox (hdlr) 211 stores a declaration of the handler type for analyzing the structure of the meta box 202. In the HEIF file 200 generated by the image capturing apparatus 100 of the present embodiment, the stored pieces of encoded data are all still images, and the hdlr box 211 is set with “pict” for a handler type name.

A PrimaryItemBox (pitm) 212 specifies an identifier (item ID) of the encoded data corresponding to a representative item from among the image items to be stored by the HEIF file 200.

An ItemLocationBox (iloc) 213 stores information indicating the storage place of each image item in the HEIF file 200. The iloc box 213 representatively describes the storage place of the image item as a byte offset from the head of the HEIF file 200 or a data length from the head. In other words, with the information of the iloc box 213, the location of each piece of the encoded data 241 stored in the mdat box 203 can be specified.

An ItemInfoBox (iinf) 214 defines the basic information (item information), such as item ID, item type indicating item category, and the like, for all of the image items (encoded data 241) included in the HEIF file 200.

An ItemReferenceBox (iref) 215 stores information describing the association between items included in the HEIF file 200. In a mode in which the image item is a captured image, the iref box 215 is used to describe the association between an image item and an item of the shooting information (Exif data or the like). In a mode in which a plurality of image items are related to a derived image, the iref box 215 is used to describe the association between the image items.

ItemPropertiesBox (iprp) 216 stores various types of property information (item property) of the image items included in the HEIF file 200. More specifically, the iprp box 216 includes an ItemPropertyContainerBox (ipco) 221 describing the property information and an ItemPropertyAssociation (ipma) box 222 indicating the association between the property information and each image item. The ipco box 221, for example, may store property information, such as entry data indicating the HEVC parameter set required to decode the HEVC image item, entry data indicating, using pixels as the unit, the width and height of the image item, and the like. The ipma box 222 stores entry data indicating the association between each image item (item ID) stored in the mdat box 203 and the property information stored in the ipco box 221.

A GroupsListBox (grpl) 217 stores the information (group information) for grouping the encoded data 241 stored in the mdat box 203. With the group information, the image items and tracks can be grouped and defined. The grpl box 217 stores, for the groups defined by the group information, the group IDs for identifying the groups and the group types of the groups. Also, the grpl box 217 stores the item IDs and track IDs for identifying the image items and tracks included in the group. Group type is a concept for specifying the relationship for the plurality of image items included in the group. The group type can use an AutoExposureBracketingEntityToGroupBox (aebr) 231 indicating that the plurality of image items is a series of captured image data acquired by automatic exposure bracketing shooting, for example. With the group type, the plurality of image items included in a group can be treated as a meaningful group unit. Note that in the example described herein, a group of a group type relating to bracketing shooting is used. However, the group type may alternatively include a group type indicating substitutable images or a group type corresponding to favorites or album.

### Adding Region Correspondence Relationship

However, in known HEIF file as described above, for a region in a discretionary image item, the structure does not easily allows an image item indicating a different representation of the object of the region to be referenced. In other words, in a known HEIF file, taking into account the relationship between image items and including information of a region able to present an image item of another representation or information for specifying an image item of another representation to be presented for the region is not taken into account. Thus, when viewing a discretionary image item of the HEIF file, when you want to view an image of another representation for a specific region, for whether or not to include an image item of another representation or for which image item to present, the user is required to each time perform a confirmation or an operation.

In the present embodiment, the structure (mainly the metadata structure) of the HEIF file configured to allow easy referencing of another image item indicating a different representation of the object of a region in an image item is newly defined. In the mode described below, region information data (RegionItem) 242 is included in the mdat box 203 as information for specifying a region, and the association between the data and the encoded data 241 is defined using metadata.

### Defining Region Information Data

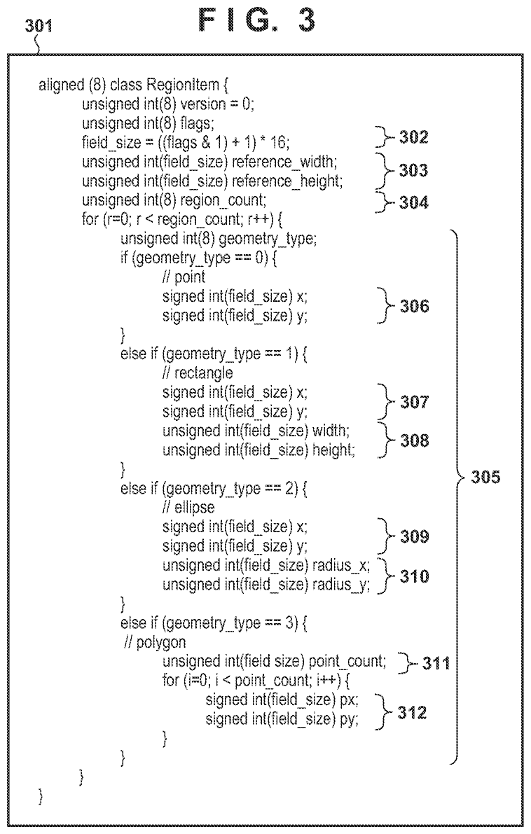

Firstly, definition 301 in FIG. 3 indicates the data structure of the region information data (RegionItem) 242 stored in the mdat box 203 of the HEIF file of the present embodiment. Note that hereinafter, the region information data 242 stored in the mdat box 203 may be referred to as the different term “region item” as appropriate.

As described in the definition 301, the single piece of region information data 242 includes data size information 302 indicating the size (field_size) of the parameter used in the data structure. In the present embodiment, the size used in the data structure in the region information data 242 is configured to be switchable between 16 bit and 32 bit, and which data size is set to is determined on the basis of the flags value.

In addition, the definition 301 includes spatial size information 303 indicating the two-dimensional size of the reference space for defining the region relating to the region information data 242. The HEIF file is capable of storing image data of various image sizes, and, because the image size can be changed by editing, it is not efficient to store the region information data 242 for each image size of the stored image data. Thus, in the present embodiment, by introducing a reference space for allocating the image data size which is the target of the region information data 242 and determining the various types of information of the region for the reference space, region definition independent of the image size of the image data is relatively performed. For example, in a mode in which the reference space is 1024 px×512 px, the region specified for image data of the same image size is determined in the image data using the position and values equal to the width and the height indicated in region shape information 305 described below. For example, a region specified for image data of 2048 px×1024 px is determined in the image data using the position and values equal to double the width and the height indicated in the region shape information 305 described below. In other words, the region information data 242 defines the position and shape of the region relative to the overall image data, and the spatial size information 303 determines the two-dimensional size of the reference space allocated with respect to the overall image data. As illustrated, the spatial size information 303 includes a reference_width indicating the width of the reference space and a reference_height indicating the height of the reference space.

Also, the definition 301 includes region number information 304 indicating the number of regions (region_count) defined by the region information data 242 and the region shape information 305 indicating the shape (geometry_type) of the region for each defined region. In the region information data 242 of the present embodiment, the shape of the region can be selected from a point, a rectangle, an ellipse, and a polygon, and the shape is specified via the value of geometry_type. Note that in the present embodiment described herein, four types of two-dimensional shapes are selectable for the region. However, the present disclosure is not limited thereto. It should be easily understandable that, as long as a discretionary space in the image data can be specified, for example, other shapes such as a line, polygonal line, a reference mask for referencing other images, an inline mask, 3D shapes, and the like may be used for the region shape information 305.

Here, regarding the region shape information 305, the method of describing the region-specific detailed parameters is different depending on the shape. In a case in which the shape is a point (geometry_type is 0), the region is specified by position information 306 indicating the coordinates of the point in the reference space. In a case in which the shape is a rectangle (geometry_type is 1), the region is specified by position information 307 indicating the coordinates of the upper left point (reference point) of the rectangle in the reference space and shape definition information 308 indicating the width and the height of the rectangle. In a case in which the shape is an ellipse (geometry_type is 2), the region is specified by position information 309 indicating the coordinates of the center of the ellipse in the reference space and shape definition information 310 indicating the length of the radius in the x-axis direction and the radius in the y-axis direction of the ellipse. In a case in which the shape is a polygon (geometry_type is 3), the region is specified by vertex number information 311 indicating the number of vertices of the polygon in the reference space and position information 312 indicating the coordinates of the vertices.

### Adding Information to Metadata

Next, using the region information data 242 configured in accordance with a definition such as that described above, a region is set for any one of the image items stored in the HEIF file 200, and the configuration of the metadata is made different to specify another image item to be associated with the region. With the image capturing apparatus 100 of the present embodiment, by adding information related to the region information data 242 to the boxes under the meta box 202, for a region in the specific image item, referencing the image item of another representation is made easy.

Firstly, in the HEIF file 200 of the present embodiment, because the encoded data 241 and the region information data 242 are stored in the mdat box 203, to recognize these, the item type is set in each piece of data in the iinf box 214. The item type is set to “hvc1” in the case of the encoded data 241 and is set to “rgan” in the case of the region information data 242, for example. Also, the storage place in the HEIF file 200 of the region information data 242 stored in the mdat box 203 is stored in the iloc box 213 in a similar manner to the encoded data 241.

Furthermore, because the region information data 242 is information for relatively specifying the region in the reference space as described above, an image item for setting a region must be specified. Information of whether a single piece of region information data 242 sets a region for any one of the image items (encoded data 241) stored in the mdat box 203 is stored in the iref box 215. In other words, because the iref box 215 describes the association between items stored in the mdat box 203, for example, for the region information data 242, this data is used to store the information for identifying the encoded data 241 for setting the region in the box.

Regarding a region set for a specific image item in this manner, so that the image item indicating a different representation of the object of the region can be easily referenced, the region information data 242 is also associated with the image item (encoded data 241) indicating the different representation. In other words, in the iref box 215, information for identifying another image item (encoded data 241) different from the image item with a set region, from among the image items stored in the mdat box 203, is also associated with a single region item.

This information in the iref box 215 is configured to be identifiable by having different reference types. More specifically, for the region information data 242, in the case of associating the encoded data 241 for setting a region using the data, information with “cdsc” specified as the reference type is stored. On the other hand, for the region information data 242, in the case of associating so that another image item can be referenced for a region set via the data, information with “eroi” specified as the reference type is stored.

Furthermore, in the HEIF file 200 of the present embodiment, in a case in which the image item with a set region is displayed, a description to add to the region and information that can present what kind of image item the other image item able to be referenced for the region is are included. The information is stored in the ipco box 221 of the iprp box 216 as property information and is associated with the region information data 242 in the ipma box 222.

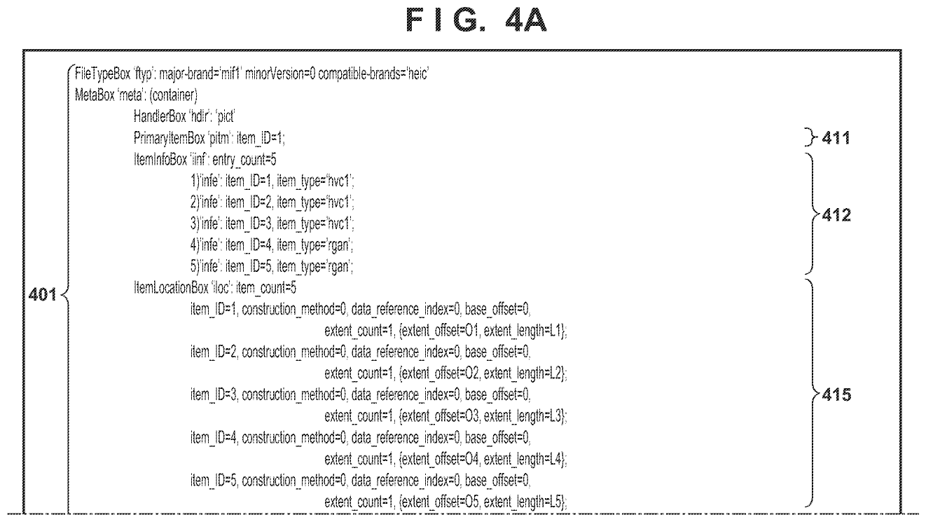

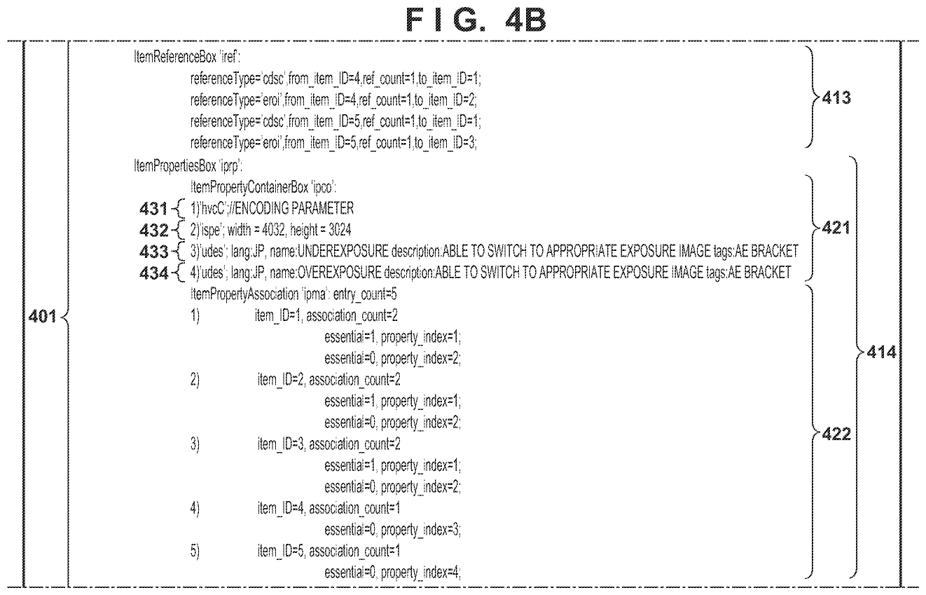

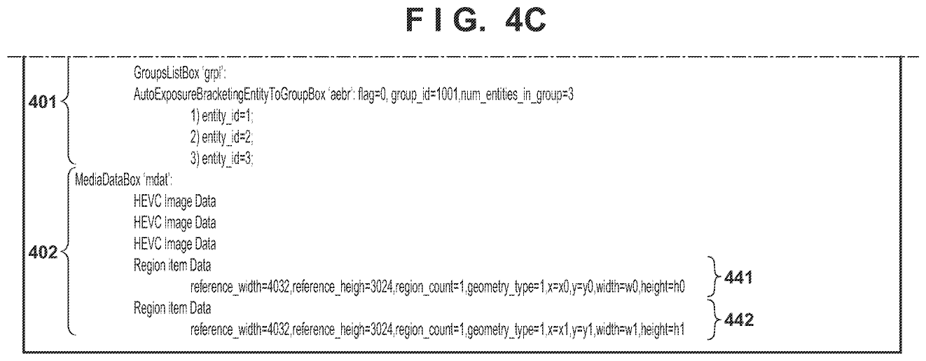

FIGS. 4A, 4B and 4C are diagrams illustrating an example of the configuration of an image file generated by the image capturing apparatus 100 of the present embodiment. Note that in the present embodiment, the image file is configured to store three types of image data acquired via automatic exposure bracketing shooting (image data with no exposure correction and image data captured with ±1 exposure correction). The encoded data 241 related to the three types of image capture is stored in the mdat box 203 of the image file in order of shooting, and, of these, the encoded data 241 with no exposure correction captured first is selected as a representative item of the image files.

In the example of FIG. 4C, as illustrated by description 402 corresponding to mdat box 203, an image file storing the encoded data (HEVC Image Data) 241 of the HEVC and the region information data (Region item Data) 242 is used an example. More specifically, the image file, in addition to the three types of image items described above, also stores a region item for setting two types of regions. As indicated in descriptions 441 and 442, each piece of region information data 242 is compliant with the definition 301 illustrated in FIG. 3, and for all the reference spaces with an image size of 4032 px×3024 px, a rectangular region is specified. Also, the regions specified with the same description are different in terms of the coordinates ((x0, y0) and (x1, y1)) of the reference point in the reference space of the region and the image size ((w0×h0) and (w1×h1)).

In the image file illustrated in FIGS. 4A, 4B and 4C, for the image item captured without exposure correction, i.e., the representative item, a dark portion or a light portion of the region is set by the region information data 242, and the image item with a different exposure representation is associated with this region. More specifically, so that the image item in which the object of the region more brightly captured can be referenced, the image item captured with a +1 exposure correction is associated with the black clipping (underexposure) region. Also, so that the image item in which the object of the region more darkly captured can be referenced, the image item captured with a −1 exposure correction is associated with the white clipping (overexposure) region.

Accordingly, in a description 401 corresponding to the meta box 202, each type of information for the region information data 242 is indicated.

A description 411 corresponds to the pitm box 212, and, so that the representative item is indicated as the first encoded data 241 stored in the mdat box 203, item_ID is set to 1.

A description 412 corresponds to the iinf box 214 and indicates the item information (item ID (item_ID) and item type (item_type)) for each item stored in the mdat box 203. In the example of FIGS. 4A, 4B and 4C, the three types of encoded data 241 and the two types of region information data 242 are stored in the mdat box 203, meaning that the entry_count is 5 and that the five types of information are listed in a description 412. In the illustrated image file, the first to third pieces of information correspond to the encoded data 241, and the fourth and fifth pieces of information correspond to the region information data 242. Accordingly, different item types (item_type) are associated with the encoded data 241 and the region information data 242, with “hvc1” being set to the former and “rgan” being set to the latter. The encoded data 241 stored in the mdat box 203 and the association between the region information data 242 and the storage place of each item is specified by a description 415 corresponding to the iloc box 213.

A description 413 corresponds to the iref box 215 and indicates the reference relationship (association) between each region item and the image item. In the illustrated example, items with the item_ID of 4 and 5 are region items. Thus, the reference relationships of different reference types (reference_type) “cdsc” and “eroi” are specified on the basis of referencing the from_item_ID and the items. More specifically, the reference relationships of the reference type “cdsc” all set a region with respect to a representative item. Thus, the item ID (to_item_ID) of a reference destination time is set to 1. Also, the reference relationships with a reference type of “eroi” are associated with another image item near the appropriate exposure for each region. Thus, the item IDs of the reference destination items are different. In the illustrated example, because the region set by the region item with an item_ID of 4 specifies a region of underexposure with respect to the representative item, as the image item associated with the region, the to_item_ID is set to 2, which is the item_ID of the encoded data 241 with a +1 exposure correction. In the illustrated example, because the region set by the region item with an item_ID of 5 specifies a region of overexposure with respect to the representative item, as the image item associated with the region, the to_item_ID is set to 3, which is the item_ID of the encoded data 241 with a −1 exposure correction.

A description 414 corresponds to the iprp box 216 and includes a description 421 corresponding to the ipco box 221 and a description 422 corresponding to the ipma box 222. The description 421 lists, as entry data, the property information able to be used in each item stored in the mdat box 203.

As illustrated, the description 421 includes, in addition to a description 431 indicating the encoding parameters included in a known HEIF file and a description 432 indicating the image size of the image item, descriptions 433 and 434 indicating annotations for the region.

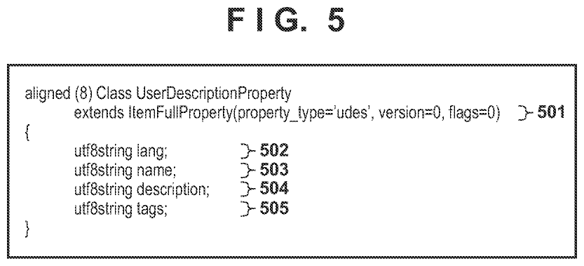

Here, the property information (annotation information) for indicating an annotation relating to the descriptions 433 and 434 may be defined by a data structure (UserDescriptionProperty) such as that illustrated in FIG. 5. As illustrated in description 501 in FIG. 5, the property type can be identified by the four character code (4CC) “udes” for identifying that the annotation information is a UserDescriptionProperty.

In the example of FIG. 5, the annotation information includes language information (lang) 502 for specifying the language the annotation is described in. The language information may store a language tag character string compliant with RFC 5646. Also, the annotation information includes name information (name) 503, annotation description information (description) 504, and tag information (tag) 505 configured of the language specified in the language information. Here, the name information 503 is information indicating, in a manner readable by a human, the name of the item or entity group associated with the annotation information. Also, the annotation description information 504 is information indicating, in a manner readable by a human, a description or phrase presented as an annotation about the item or entity group associated with the annotation information. Also, the tag information 505 is information indicating a tag defined by the user or automatically allocated for associating with an item associated with the annotation information and is capable of including a plurality of tags split up by commas.

Accordingly, the annotation information indicated in the description 433 and 434 in FIGS. 4A, 4B and 4C have “udes” attached indicating that they are user description information and are identified as other property information. In the example of FIGS. 4A, 4B and 4C, the descriptions 433 and 434 both have Japanese (JP) as the lang, and “able to switch to appropriate exposure image (with respect to the object of the region)” as the description. In the description 433, the annotation information for a region of underexposure is indicated, and “underexposure” is set in the name. In the description 434, the annotation information for a region of overexposure is indicated, and “overexposure” is set in the name. Also, regarding the region of the representative item, the image item which can switch representation in response to an instruction to change to another representation is image data acquired together with the representative item via AE bracket shooting. Thus, “AE bracketing” is set for the tags of both descriptions.

The property information listed in the description 421 in this manner is associated with each item stores in the mdat box 203 in the entry data of the description 422 corresponding to the ipma box 222. In the example of FIGS. 4A, 4B and 4C, a common “ispe” (property index of 2) is associated with the image items with an item ID of 1 to 3 indicating that they have the same image size. In a similar manner, a common “hvcC” (property index of 1) is associated with the image items with an item ID of 1 to 3 indicating that they have the same encoding parameter. However, in the region items with an item ID of 4 and 5, different “udes” (property_index of 4 or 5) are associated, indicating that the region items are an underexposure region or an overexposure region. In this manner, via association with the “udes” property, assignment of annotation information to a region is implemented.

Note that in the present embodiment described herein, the annotation information is configured by the definition illustrated in FIG. 5. However, the configuration of the annotation information is not limited thereto, and the mode of including information in the metadata is not limited to that illustrated in FIGS. 4A, 4B and 4C.

### Generation Processing

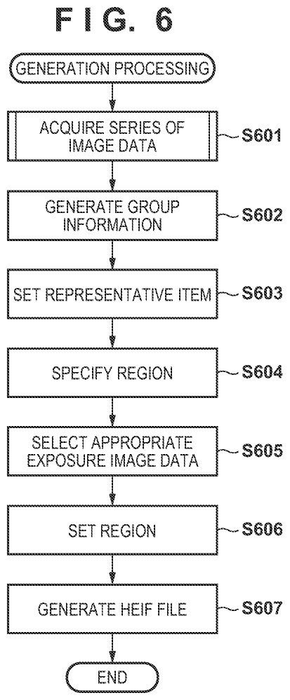

The generation processing to generate a HEIF file storing three types of image data acquired via AE bracket shooting executed by the image capturing apparatus 100 of the present embodiment will be described in detail below with reference to FIG. 6. The processing corresponding to the flowchart is implemented by the CPU 101 by reading a corresponding processing program stored in the ROM 102 and loading the program on the RAM 103 to cause the blocks to operate. Note that the present generation processing described herein is started when the mode is set to AE bracket shooting mode and an operation input relating to shooting in this mode is detected.

In step S601, the CPU 101 controls the image capturing unit 104 and the image processing unit 105 and acquires a series of image data for storing in the HEIF file. As described above, the series of image data acquired in the generation processing of the present embodiment corresponds to the three types of image data acquired by AE bracket shooting.

### Acquisition Processing

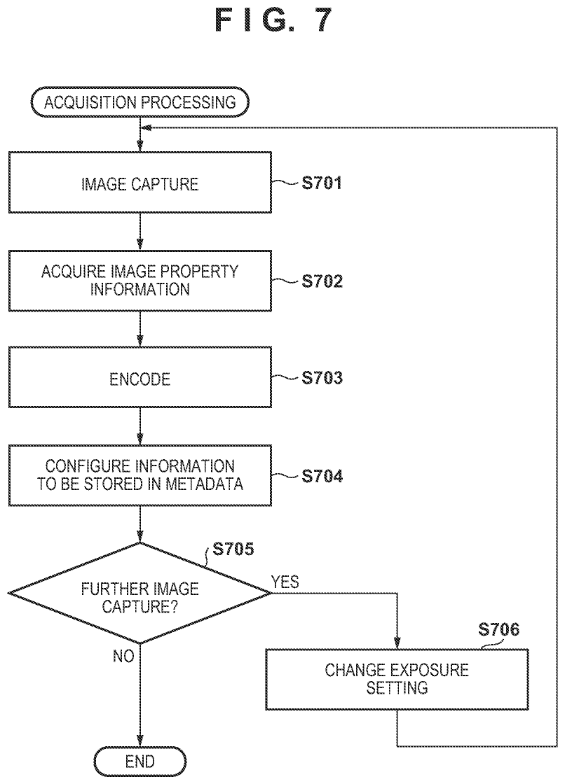

The acquisition processing to acquire the series of image data for storing in a HEIF file executed by the image capturing apparatus 100 of the present embodiment will be described here in detail with reference to the flowchart of FIG. 7.

In step S701, under the control of the CPU 101, the image capturing unit 104 performs image capture at a predetermined exposure setting (exposure parameter) and outputs the acquired digital image data. As described above, in the image capturing apparatus 100 of the present embodiment, three types of image capture, no exposure correction, exposure correction +1, and exposure correction −1, are performed. Thus, when the processing of the present step is executed for the first time, the exposure setting is set to no exposure correction.

In step S702, under the control of the CPU 101, the image processing unit 105 analyzes the image data output in step S701 and acquires image property information. The image property information, for example, may include the width and height of the image data, the number of color components, the bit length, and the like.

In step S703, under the control of the CPU 101, the encoding/decoding unit 111 HEVC encodes the digital image data output in step S701 and transfers and stores the acquired encoded data in the output buffer of the RAM 103. Here, the post-HEVC encoded encoded data may be transferred to the output buffer as the encoded data without change or may be transferred after re-encoding using a specific parameter. Note that the encoded data stored in the output buffer in the present step is data stored as the encoded data 241 in the mdat box 203. Hereinafter, the encoded data is simply referred to as image data.

In step S704, under the control of the CPU 101, the metadata processing unit 112 configures the information to be stored in the metadata for the image data stored in step S703. The information to be stored in the metadata for the image data includes item information, property information, and the like of the image including encoding parameters and the like. In other words, the metadata processing unit 112 configures item information to be stored in the iinf box 214 for the image data and entry data relating to the property information to be stored in the ipco box 221 and the ipma box 222 of the iprp box 216. Here, the encoding parameter included in the item information includes a video parameter set (VPS), a sequence parameter set (SPS), a picture parameter set (PPS), and the like. The information configured in the present step is stored in the output buffer of the RAM 103 as a portion of the metadata stored in the HEIF file.

In step S705, the CPU 101 determines whether or not to cause the image capturing unit 104 to further output digital image data. In other words, the CPU 101 determines whether or not there is an exposure setting not yet used in image capture relating to AE bracket shooting. In a case in which the CPU 101 determines to cause the image capturing unit 104 to further output digital image data, in step S706, the CPU 101 changes the exposure setting relating to the next image capture, and then returns the processing to step S701. In a case in which the CPU 101 determines not to cause the image capturing unit 104 to further output digital image data, the CPU 101 finishes the present acquisition processing.

By acquiring a series of image data via executing acquisition processing in this manner, in step S602 of the generation processing under control of the CPU 101, the metadata processing unit 112 generates group information that allows the series of image data to be identified as a group. Specifically, to form a group out of the image group acquired via AE bracket shooting, the metadata processing unit 112 configures group information (information to be stored in the aebr box 231) of the group type of the AE bracket shooting. In the group information, the item ID for specifying the series of image data acquired in step S601 is stored.

In step S603, under control of the CPU 101, the metadata processing unit 112 sets one of the pieces of image data from among the series of image data to be stored in the HEIF file as the representative item, configures the information for storing in the pitm box 212, and stores this in the output buffer. In the image capturing apparatus 100 of the present embodiment, in the AE bracket shooting, a piece of image data acquired via image capture with no exposure correction is set as the representative item. However, the representative item setting method is not limited thereto.

In step S604, under the control of the CPU 101, the image processing unit 105 executes analysis processing on the image data set as the representative item and specifies the region (region without appropriate tone representation) without appropriate exposure. In the image capturing apparatus 100 of the present embodiment, a region with underexposure and a region with overexposure are specified as a region without appropriate exposure.

Note that to facilitate understanding of the present disclosure, the present embodiment has been described such that, in the present step, the underexposure region and the overexposure region can be divided and specified. However, the present disclosure is not limited thereto. For example, in a case in which there are four or more types of series of image data acquired via bracketing shooting, the single region specified in the present step is included in a wide area within the representative item, and a plurality of regions (objects) with different appropriate exposures are included in the region, the region may be specified after further division. At this time, regions without appropriate exposure image data may be removed from being the generation target of the region information data 242.

In step S605, under the control of the CPU 101, for each region specified in step S604, the selecting unit 114 selects image data with the most appropriate exposure of the object in the region from among pieces of image data that are not the representative item. In other words, the image data acquired via image capture with +1 exposure correction is selected for the region of underexposure, and the image data acquired via image capture with -1 exposure correction is selected for the region of overexposure.

In step S606, under the control of the CPU 101, the setting unit 113 configures the various types of information for treating the regions specified in step S604 as a region item and sets the region. Here, the various types of information include the region information data 242 for the region and the information stored in the iloc box 213, the iinf box 214, the iref box 215, and the iprp box 216 for the region or the region information data. More specifically, the region information data 242 is adaptively configured to include the region shape information 305 in accordance with the shape of the region, for example. Also, the information stored in the iinf box 214 is configured to include the item ID for identifying the region item and information of the item type indicating that it is a region item. Also, the iloc box 213 is information indicating the data position within the HEIF file. Furthermore, the information stored in the iref box 215 and the iprp box 216 are information to be associated with the region information data 242. One type of information to be stored in the iref box 215 for each region item is first specifying information, i.e., the reference type “cdsc”, for specifying the region in the representative item by associating the region information data 242 with the representative item. Also, one more type of information to be stored in the iref box 215 for each region is information of the reference type “eroi” for specifying the image item with appropriate exposure of the object of the region that is able to be referenced for the region specified by the region information data 242. The latter information (second specifying information) includes item_ID of the image data selected in step S605 for each region. Also, the information stored in the iprp box 216 is annotation information described in relation to the descriptions 433 and 434 using FIGS. 4A, 4B and 4C and configures the specified region with respect to underexposure and overexposure. The information configured in this manner are stored in the output buffer of the RAM 103.

In step S607, under the control of the CPU 101, the generating unit 115 generates a HEIF file. More specifically, the metadata processing unit 112 configures the final metadata of the HEIF file on the basis of the information stored in the output buffer. Also, the generating unit 115 combines the information of the ftyp box 201 relating to the HEIF file, the information of the meta box 202 storing the final metadata, and the information of the mdat box 203 storing the series of image data and the region information data. Then, the CPU 101 writes and stores the HEIF file generated by combining from the RAM 103 to the non-volatile memory 120.

In this manner, in the image capturing apparatus 100 of the present embodiment, for the image file storing the series of image data acquired by image capture with different exposure settings, image data with appropriate exposure can be associated with a region without appropriate exposure in one piece of the image data. Also, by further associating the annotation information, that other pieces of image data can be referenced with respect to the region can be easily identified.

Note that in the present embodiment, a mode in which the series of image data to be stored in the image file is acquired via image capture by the image capturing unit 104 has been described. However, the present disclosure is not limited thereto. It goes without saying that series of image data may be image data stored in advance in the ROM 102 or the non-volatile memory 120 or may be image data received via the communication unit 108. In this case, the series of image data may include a HEIF file storing one still image or may include a still image file such as a JPEG. Alternatively, the series of image data may be image data encoded in a HEIF file storing a plurality of pieces of still image data or may be unencoded RAW image data.

Also, the series of image data is not limited to image data acquired via AE bracket shooting as described above, and as long as at least a portion of the object is common across different image data, the present disclosure can be applied. For example, the series of image data may be an image data group acquired via white balance bracketing shooting, focus bracketing shooting, flash bracketing shooting, depth of field bracketing shooting, ISO bracketing shooting, or the like. Also, in the present embodiment, a mode in which the image data acquired by image capture while sequentially changing the image capture conditions is stored as a series of image data has been described. However, for example, from a RAW image or the like acquired from a single image capture, an image data group may be generated and stored in a similar manner. In other words, from a RAW image or the like, a plurality of types of image data with different image capture conditions may be generated and stored in the image file as a series of image data.

Also, to facilitate understanding of the disclosure, the present embodiment has been described such that three types of image data with different exposure settings are acquired via AE bracket shooting and an image file storing these is generated. However, it should be understood that the present disclosure is not limited thereto. In other words, the image data acquired as the series of image data is not limited to three types, and any number is sufficient as long as it is a plurality.

Also, in the present embodiment, a mode in which the region setting number is not limited and a single other piece of image data for each region is associated in a manner allowing for referencing has been described. However, the present disclosure is not limited thereto. The number of regions able to be set for a single image file, in other words the number of pieces of region information data 242 able to be stored in the mdat box 203, may have an upper limit. Also, the number of other pieces of image data associated with one region in a manner allowing referencing may be two or more.

Also, in a case in which the image file is configured in a manner allowing the image data to be displayed in a derived image format, a plurality of sub-images may be stored in the mdat box 203 as the encoded data 241. In such a configuration, in a case in which a region is set in a derived image, the item information and property information to be stored in the metadata may be configured for each one of the sub-images in addition to the derived image.

### Use of Image File

Next, a mode of how a HEIF file generated in this manner is used will be described. Here, it should be easily understood that the HEIF file can be used in a discretionary apparatus and is not limited to being used in the image capturing apparatus 100 which generated the file. In use, a processor such as the CPU of the apparatus reads the meta box 202 of the HEIF file which is the processing target, so that the encoded data 241 and the region information data 242 stored in the mdat box 203 can be played back and changed.

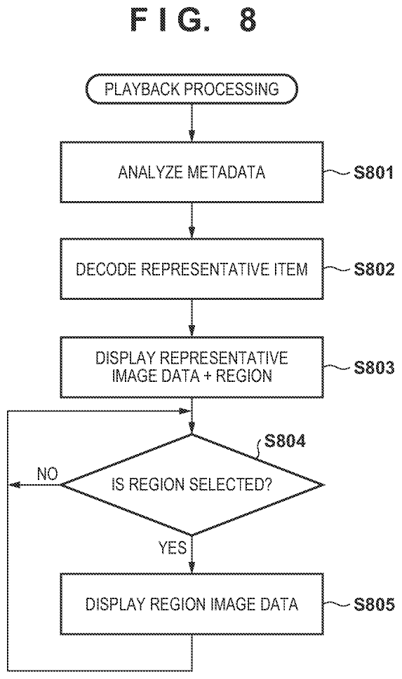

As a mode of how the HEIF file is used, playback processing to playback (display) the HEIF file in the image capturing apparatus 100 will be described below with reference to the flowchart of FIG. 8. The processing corresponding to the flowchart is implemented by the CPU 101 by reading a corresponding processing program stored in the ROM 102 and loading the program on the RAM 103 to cause the blocks to operate. Note that the present playback processing described herein is started when an operation input relating to a HEIF file playback instruction is detected with the image capturing apparatus 100 set to playback mode, for example.

In step S801, the CPU 101 acquires the metadata stored in the meta box 202 of the playback target HEIF file (target file) for which there was a playback instruction. Then, by the metadata processing unit 112 analyzing the acquired metadata, the configuration of the target file is determined.

In step S802, the CPU 101 specifies a representative item on the basis of the information of the pitm box 212 of the metadata and causes the encoding/decoding unit 111 to decode the encoded data 241 of the representative item and store it in the buffer. Hereinafter, to facilitate understanding of the present disclosure, the image data of the representative item decoded and stored in the buffer is referred to as “representative image data”.

In step S803, the CPU 101 causes the display unit 106 to display the representative image data stored in the buffer in step S802 together with information indicating the set region. More specifically, the CPU 101 references the region information data 242 on the basis of the information of the reference relationship (reference relationship with a reference type of “cdsc”) for setting the region in the representative image data included in the iref box 215 of the metadata. Then, the CPU 101 specifies a region in the representative image data on the basis of the region information data 242 and causes it to be displayed together with the representative image data. The information indicating the set region may be configured as a two-dimensional image item according to the shape, and the region indicated by the region information data 242 may be superimposed on the representative image data. Also, the CPU 101 may add the information determined by the annotation information associated with the region and may further present the region state (underexposure/overexposure) or that the image with appropriate exposure for the region can be presented.

In step S804, the CPU 101 determines whether or not an operation input relating to selecting any one of the regions indicated in the representative image data has been detected. In a case in which the CPU 101 determines that an operation input relating to region selection has been detected, the CPU 101 stores the information for specifying the region in the RAM 103, and moves the processing to step S805. In a case in which the CPU 101 determines that it has not been detected, the CPU 101 repeats the processing of the present step. Here, whether or not an operation input relating to region selection is detected may be determined on the basis of a touch operation on the representative image data displayed on the display unit 106 or information of the position of the touch operation, for example. Note the operation input relating to region selection is not limited thereto, and, for example, a discretionary user interface provided on an apparatus for target file playback may be used, for example.

In step S805, the CPU 101 causes the encoding/decoding unit 111 to decode the encoded data 241 associated with the selected region and cause the display unit 106 to display the acquired image data (region image data) superimposed on the representative image. Then the CPU 101 returns the processing to step S804. The region image data display may be performed by superimposing a reduced display of the region image data or may be performed by extracting and superimposing an image of the region selected from the region image data.

In this manner, in a case in which, upon playback of the target file, the user is notified of the presence of the region set for the representative image data and the region is selected, image data indicating a different representation of the object of the region can be further presented.

Note that in the present embodiment described herein, the image data is displayed superimposed on the representative image data. However, the present disclosure is not limited thereto. For example, the region image data may be displayed by suspending display of the representative image data and being switched to.

Also, in the present embodiment described herein, the region image data is displayed in response to an operation input relating to region selection being detected. However, the operation input that triggers displays is not limited to being one for selection. For example, in a case in which an operation input relating to an instruction to magnify the representative image data is detected, the region image data corresponding to a region included in the magnified display area may be displayed.

Also, in the present embodiment described herein, the region set for the representative image data is displayed together with the representative image data. However, the present disclosure is not limited thereto. In other words, it is sufficient that, when playing back the representative image data included in the image file, another piece of image data indicating a different representation of the object of the region in the representative image data can be specified, and displaying the region is not a required configuration of the present disclosure. In other words, it is sufficient that the information of the region set in the representative image data for playback is used to detect an operation input relating to displaying another piece of image data and is determined in the internal processing not relating to the display output, for example.

Also, in the present embodiment, generation processing to generate an image file with a region set for a representative item and playback processing to display this are described. However, the present disclosure is not limited thereto. In other words, the image data with the region set is not limited to being a representative item and may be any of a series of image data to be stored in an image file. In this case, it is sufficient that the region is set for a region without appropriate exposure in the image data, for example. Also, in a case in which, upon playback, the CPU 101 determines whether or not a region is set for the image item for which there was a playback instruction and determines that a region is set, it is sufficient that processing similar to that of steps S803 to S805 described above is executed.

Note that the present embodiment described herein is a mode for using the image file in which, when one piece of image data stored in the image file is displayed, another piece of image data indicating a different representation of the set region to the image data is able to be displayed. However, the present disclosure is not limited thereto. It is sufficient that the present disclosure is configured so that, for at least one piece of image data from the image data group stored in the image file, information of another piece of image data indicating a different representation of the object of the region set in the image data can be acquired.

The information of the another image data is not limited to being used for display and can be used when extracting image data with a different representation of a specific object from an image file, for example.

### Second Embodiment

The embodiment described above is a mode in which, from an acquired series of image data, a piece of image data acquired by image capture with no exposure correction is set as the representative item, and a region for associating another piece of image data is set on the basis of the image data. However, the present disclosure is not limited thereto. The present embodiment described herein is a mode in which combined image data generated using a series of image data is included in an image file as a representative item, and a region is set on the basis of the combined image data.

### Generation Processing

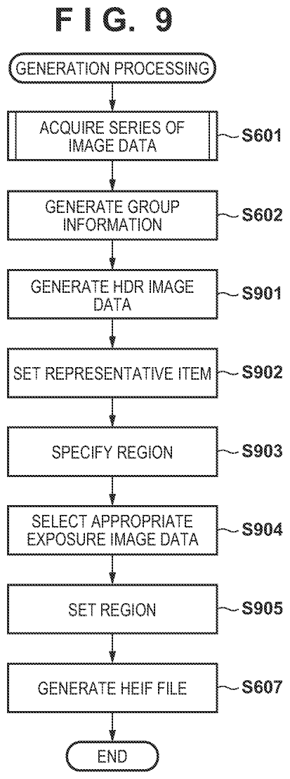

The generation processing to generate an image file according to the present embodiment is different from that of the first embodiment in terms of the contents of the flowchart in FIG. 9. The generation processing of the present embodiment generates a HEIF file storing image data (High Dynamic Range (HDR) image data) acquired by combining three types of image data acquired via AE bracket shooting and will be described in detail below with reference to FIG. 9. The processing corresponding to the flowchart is implemented by the CPU 101 by reading a corresponding processing program stored in the ROM 102 and loading the program on the RAM 103 to cause the blocks to operate. Note that the present generation processing described herein is started when the mode is set to HDR image generation mode and an operation input relating to shooting in this mode is detected. Also, hereinafter, the steps of processing similar to that of the first embodiment are given the same reference number and description thereof is omitted.

In step S602, when group information is generated, in step S901, the image processing unit 105 generates HDR image data under the control of the CPU 101. More specifically, for example, the image processing unit 105 performs HDR merging after tone mapping based on the exposure settings of the series of image data acquired in step S601 to generate image data with an expanded dynamic range. Then, the encoding/decoding unit 111 generates HDR image data by HEVC encoding the image data acquired via combining. The image processing unit 105 stores the generated HDR image data in the output buffer. Also, the metadata processing unit 112 configures the information (including item information and property information) to be stored in the metadata for the image data acquired via combining and stores this in the output buffer.

In step S902, under control of the CPU 101, the metadata processing unit 112 sets the HDR image data generated in step S901 as the representative item, configures the information for storing in the pitm box 212, and stores this in the output buffer.

In step S903, under the control of the CPU 101, the image processing unit 105 executes analysis processing on the HDR image data set as the representative item and specifies the region in the image data. Specifying a region in the present step is performed on the basis of whether or not, via image processing such as contrast adjustment in the HDR merging, the image representation has become unnatural compared to the original image. Here, an unnatural image representation may be determined using a threshold for color development or the degree of enhancement of brightness difference, for example. Here, one or more regions may be specified. Also, a region may be specified by limiting and specifying a main region after recognition of the object in the HDR image data is performed, for example.

In step S904, under the control of the CPU 101, for each region specified in step S903, the selecting unit 114 selects image data with the most appropriate exposure of the object in the region from the series of image data acquired in step S601.

In step S905, under the control of the CPU 101, the setting unit 113 configures the various types of information for treating the regions specified in step S903 as a region item, stores them in the output buffer, and sets the region.

In this manner, an image file can be generated for which the relationship between the combined image and the series of image data can be easily referenced, as opposed to the relationship between acquired series of image data. According to the image file, in a case in which a region with an unnatural image representation is included in the HDR image data set as the representative item, the captured image data corresponding to the region can be easily referenced, making it easy to determine whether or not adjustment of the parameters for combining or combining is necessary.

Note that in the present embodiment describe herein, the HDR image data is image data acquired by combining a series of image data. However, the present disclosure is not limited thereto, and the image data may be generated via another type of combining processing. Also, in the present embodiment, a mode in which, for a region set in the HDR image data, the object of the region is associated with image data with appropriate exposure has been described. However, the present disclosure is not limited thereto. The image data associated with the region may be one or more pieces of image data used in generating a pixel of the region, for example, and in this case, image data of a representation before applying adjustment relating to combining can be easily referenced for the object of the region.

### Third Embodiment

In the first embodiment described above, a series of image data acquired via image capture with sequentially different exposure setting is acquired and stored in the mdat box 203 of the image file. However, the present disclosure is not limited thereto. That is, in the embodiment described above, each series of image data is an image data group indicating different representations with the same image capture angle of view. The present embodiment described herein is a mode which includes image data with different image capture angles of view acquired by changing the optical zoom magnification of a telephoto lens during image capture of a series of image data. That is, the series of image data includes image data acquired by image capture with a wide-angle image capture angle of view and image data of a magnified portion of the image data acquired by image capture with a more telephoto-like image capture angle of view.

### Generation Processing

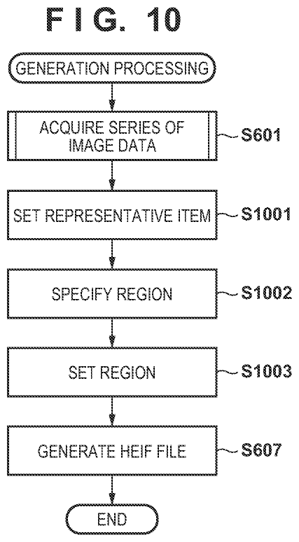

The generation processing to generate an image file according to the present embodiment is different from that of the first embodiment in terms of the contents of the flowchart in FIG. 10 and in that the image capture settings changed in step S706 of the acquisition processing correspond to changing the image capture angle of view. That is, the series of image data acquired by the acquisition processing of the present embodiment is acquired by image capture while sequentially changing the image capture angle of view, instead of being acquired by AE bracket shooting. Thus, because the relevance of the series of image data is different, the group information generation performed in step S602 of the generation processing may be omitted. Note that though the number of pieces of image data acquired in the acquisition processing is not particularly set, at least including the image data (widest-angle image data) acquired via image capture with the widest angle for the image capture angle of view, another image data is a zoom image of a partial region of the image data of the widest-angle image data.

The generation processing of the present embodiment will be described in detail below with reference to the flowchart of FIG. 10. The processing corresponding to the flowchart is implemented by the CPU 101 by reading a corresponding processing program stored in the ROM 102 and loading the program on the RAM 103 to cause the blocks to operate. Note that the present generation processing described herein is started when the mode is set to change angle of view shooting mode and an operation input relating to shooting in this mode is detected. Also, hereinafter, the steps of processing similar to that of the first embodiment are given the same reference number and description thereof is omitted.

In step S601, when a series of image data is acquired, in step S1001 under the control of the CPU 101, the metadata processing unit 112 sets the widest-angle image data from the series of image data as the representative item. Then, the metadata processing unit 112 configures the information for storing in the pitm box 212 and stores this in the output buffer. Note that in a case in which a plurality of pieces of image data captured with the widest image capture angle of view are included in the series of image data, the metadata processing unit 112 sets one of these as the representative item.

In step S1002, under the control of the CPU 101, the image processing unit 105 executes analysis processing on the widest-angle image data set as the representative item and other image data (telephoto image data) and specifies which telephoto image corresponds to which region of the widest-angle image data. In other words, the image processing unit 105 specifies, for each piece of image data (image data other than reference image data) excluding the widest-angle image data (the reference image data) from the series of image data, which region of the widest-angle image data is a zoomed image.

In step S1003, under the control of the CPU 101, the setting unit 113 configures the various types of information for treating the regions specified in step S1002 as a region item, stores them in the output buffer, and sets the region. Here, one type of information to be stored in the iref box 215 is the information of the reference type “cdsc” for associating the region information data 242 relating to the region with the image item (representative item) of the widest-angle image data. Also, one more type of information to be stored in the iref box 215 for each region is information of the reference type “eroi” for specifying the image item that is able to be referenced for the region specified by the region information data 242. In the generation processing of the present embodiment, the telephoto image data is image data with a magnified display of a portion in the widest-angle image data, and, to because the portion is specified in step S1002, the image item specified by the information of the latter is telephoto image data used to specify each region. Also, the information stored in the iprp box 216 may be different from that in the first embodiment, and text with the meaning of “magnified image” may be set in the name or tags, for example. Here, in a case in which there are a plurality of pieces of telephoto image data indicating the same region, association may be performed with all of them or with only a portion of them.

In this manner, instead of image data with different exposure representation of the region, image data with different spatial resolution of the region can be associated with the region set in the image data. According to the image file, for the region included in the widest-angle image data, the image data that enables the object to be confirmed in detail can be easily referenced. Also, in a case in which an operation input of a magnify instruction is detected for the representative item during playback of the image file, because the image size of the magnification ratio in accordance with the operation input can be specified, the associated telephoto image data of the image size can be selected and displayed.

Note that in the present embodiment described herein, for the widest-angle image data, a region corresponding to another telephoto image data is specified and associated with the telephoto image data. However, the present disclosure is not limited thereto. For example, in a case in which the series of image data is acquired with the image gradually changing from a widest-angle image to a telephoto-like image, the image data with a one level telephoto-like image capture angle of view may be associated with the image data each image capture angle of view.

Also, in the present embodiment described herein, the representative item is the widest-angle image data, and the other image data all indicate a region included in the widest-angle image data. However, the present disclosure is not limited thereto. In other words, the image data which is the representative item is not limited to being the widest-angle image data and may be the image data acquired by shooting with a different image capture angle of view. In this case, for example, the region indicated by another piece of image data may not be included in the image data in which a portion thereof is the representative item.

Also, the series of image data is not necessarily limited to being acquired by image capture with sequentially different image capture angles of view, and, for example, in an image capturing apparatus provided with optical systems of different image capture angles of view, the image data acquired with the optical systems may be the series of image data. In this case, an image data group acquired at the same image capture time can be the series of image data, and an image file can be generated in which detailed information of the object can be easily referenced on the basis of the image data on the telephoto-like side.

### Modified Example

In the embodiments described above, modes are described in which analysis processing is executed on the representative image data, i.e., the representative item, a region is set, and an image item other than the representative item is associated with the region. That is, in the modes described above, in a case in which the encoded data 241 in which the region is set is only the representative item and a region in the representative item is selected, another image item of a higher quality associated with the region can be referenced. Specifically, in the first and second embodiment, the image data indicating the representation of the appropriate exposure for the region is associated in a manner able to be referenced, and in the third embodiment, image data with a higher spatial resolution for the region is associated in a manner able to be referenced.

Alternatively, metadata may be configured such that a region indicating a representation of a higher quality than any one other image item in the group is set for each image item grouped and stored in the mdat box 203. In other words, in the present modified example, the information to be stored in the iref box 215 relating to setting the region is associated with the image item that is displayed when an operation input relating to selection of the region is detected and it is not necessarily associated with a representative item. More specifically, in this mode, the information to be stored in the iref box 215 is limited to information with the reference type “cdsc”, and information of the reference type “eroi” for associating with another image item is not included. Also, it is sufficient that the annotation information is associated with and includes text for indicating that the region has the highest quality representation, for example.

Thus, in the image file generated in the present modified example, the image item including the region indicating the most appropriate representation in the group is specified, and, for each of them, the region information data 242 for specifying the region included in the image item is associated.

Note that there may be a limit on the number of regions able to be set for the entire group, or there may be a limit on the number of regions able to be set for one image item. With such limits, in a case in which comparison is performed on a pixel basis, it is possible to specify an image with the highest quality as a region even if a pixel is not necessarily a region with good quality. In other words, the region information data 242 can be assigned per pixel, and the complexity of the processing for storage and display can be reduced.

Also, in the present modified example, the metadata for associating the region information data 242 with the image item including the region indicating the highest quality representation for each region from the image items in the group is configured. At this time, in a case in which there are a plurality of image items indicating quality of the same level, the region information data 242 may be associated with each one of the image items.

Also, upon playback of the image file including the metadata configured as such, when an operation input relating to region selection is detected after the representative item is displayed, for example, the image item associated with the region information data 242 for the region is specified and displayed. Accordingly, on a region basis, the image data indicating the most appropriate representation from the image data group included in the image file can be easily referenced.

According to the embodiments and the modified example described above, when an image file for storing a plurality of pieces of image data is used, the index of the image data to be referenced per region can be acquired from the metadata. Also, by determining a reference in terms of quality or the like in relation to selecting the image data to be referenced, the time and effort involved in the user, when using the file, to subjectively select image data to be referenced can be reduced, and image data compliant with a certain standard can be referenced.

Note that in the embodiments and the modified example described above, the series of image data to be stored in the image file is image data acquired from a series of image captures. However, the present disclosure is not limited thereto. For example, when the generated image file is used, another piece of image data relating to image capture performed at different timings may be added to the image file, and, in this case, analysis processing may be executed on the added image data, and the metadata may be changed on the basis of the result. More specifically, for the object included in the image data already stored in the image file, for example, image data of different representations can be newly added, and, at this time, information of the region that enables the image data to be reference may be added as necessary.

Also, in the embodiments described above, a region is set for the representative image data set as the representative item, and another piece of image data indicating a different representation of the object of the region is associated. However, the present disclosure is not limited thereto. The image data (reference image data) used in setting the region is not limited to representative image data, and discretionary image data to be stored in the image file may be used. Also, the image data used as reference image data in one image file is not limited to one piece of data, and one or more pieces of image data may be used as reference image data, and each may be set with a region and associated with another piece of image data with a different representation. Accordingly, for example, after the image data associated with the region set in the reference image data is displayed, if there is a region in which the image data is set as the reference image data, another piece of image data can be further referenced from the region in the image data.

Also, in the embodiments described above, mainly, the image data associated with a region in a manner allowing for referencing is image data indicating a representation of a higher quality for the object of the region. However, it should be easily understood that the present disclosure is not limited thereto. In other words, it is sufficient that the image data associated with a region is at least reference image data with a set region and image data with a different representation of the object of the region, with there being no dependence on quality.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-179729, filed Nov. 2, 2021, which is hereby incorporated by reference herein in its entirety.

What is claimed is:

1. An image processing apparatus configured to generate an image file with a structure including a first storage area configured to store a plurality of pieces of image data and a second storage area configured to store metadata relating to the plurality of pieces of image data, the metadata including first specifying information for specifying a region in a reference image data from among the plurality of pieces of image data, and second specifying information for specifying another piece of image data indicating a different representation of an object of a region specified by the first specifying information, the image processing apparatus comprising:
at least one processor configured to function as following units:
an acquisition unit configured to acquire the plurality of pieces of image data;
a first selection unit configured to select the reference image data from the plurality of pieces of image data acquired by the acquisition unit, a setting unit configured to set a region for the reference image data selected by the first selection unit;
a second selection unit configured to select, as the another piece of image data, image data different from the reference image data from among the plurality of pieces of image data with respect to a region set by the setting unit; and
a generation unit configured to generate the image file storing, in the first storage area, the first specifying information configured for a region set by the setting unit and the second specifying information configured for the another piece of image data selected by the second selection unit and storing, in the second storage area, the plurality of pieces of image data.

2. The image processing apparatus according to claim 1,
wherein the plurality of pieces of image data have at least a portion of an object in common across the pieces of image data.

3. The image processing apparatus according to claim 1,
wherein the plurality of pieces of image data include an image data group acquired by a series of image captures.

4. The image processing apparatus according to claim 3,
wherein the plurality of pieces of image data further include, in addition to an image data group acquired by the series of image captures, combined image data acquired by combining two or more pieces of image data of the image data group, and
the first selection unit selects the combined image data as the reference image data.

5. The image processing apparatus according to claim 3,
wherein the plurality of pieces of image data include image data acquired by image capture with different image capture conditions, and
the second selection unit selects image data captured with image capture conditions different from that of the reference image data as the another piece of image data.

6. The image processing apparatus according to claim 5,
wherein the image capture conditions include at least one of exposure, ISO, white balance, focus, depth of field, or image capture angle of view.

7. The image processing apparatus according to claim 6,
wherein the plurality of pieces of image data include image data acquired by image capture with different exposure settings,
the setting unit sets a region with not appropriate exposure in the reference image data, and
the second selection unit selects, as the another piece of image data, image data in which an object of a region set by the setting means has appropriate exposure.

8. The image processing apparatus according to claim 6,
wherein the plurality of pieces of image data include image data acquired by image capture with different image capture angles of view,
the setting unit, for a piece of image data other than the reference image data from among the plurality of pieces of image data, sets a corresponding region in the reference image data, and
the second selection unit selects, as the another piece of image data, image data in which an object of a region set by the setting means is displayed magnified.

9. The image processing apparatus according to claim 1,
wherein the generation unit further stores region information data indicating a position, size, and shape of a region set by the setting unit in the second storage area,
the first specifying information specifies a region in the reference image data by the region information data being associated with the reference image data, and
the second specifying information specifies that the another piece of image data is image data indicating a different representation of an object of a region specified by the first specifying information by the region information data being associated with the another piece of image data.

10. The image processing apparatus according to claim 1,
wherein the generation unit further stores annotation information of the another piece of image data in the first storage area.

11. An image processing apparatus configured to generate an image file with a structure including a first storage area configured to store a plurality of pieces of image data and a second storage area configured to store metadata relating to the plurality of pieces of image data, the metadata including specifying information for specifying a region in at least one piece of image data from among the plurality of pieces of image data, the image processing apparatus comprising:
at least one processor configured to function as following units:
an acquisition unit configured to acquire the plurality of pieces of image data;
a setting unit configured to set a region in the plurality of pieces of image data acquired by the acquisition unit;
a selection unit configured to select, from among the plurality of pieces of image data, image data indicating a most appropriate representation of an object of each region in the plurality of pieces of image data set by the setting unit; and
a generation unit configured to generate the image file configured for each piece of image data indicating the most appropriate representation selected by the selection unit and storing, in the first storage area, the specifying information for specifying a region indicating the most appropriate representation in the image data and storing, in the second storage area, the plurality of pieces of image data.

12. An image processing apparatus configured to playback an image file with a structure including a first storage area configured to store a plurality of pieces of image data and a second storage area configured to store metadata relating to the plurality of pieces of image data, the metadata including first specifying information for specifying a region in a reference image data from among the plurality of pieces of image data, and second specifying information for specifying another piece of image data indicating a different representation of an object of a region specified by the first specifying information, the image processing apparatus comprising:
at least one processor configured to function as following units:
an acquisition unit configured to acquire the image file for playback;
a first presentation unit configured to present the reference image data stored in the image file for playback; and
a second presentation unit configured to present the another piece of image data specified by the second specifying information in a case where an operation input to specify a region specified by the first specifying information is detected for the reference image data presented by the first presentation unit.

13. The image processing apparatus according to claim 12,
wherein the first presentation unit further presents a region able to be referenced in the reference image data and the another piece of image data on the basis of the first specifying information and the second specifying information.

14. An image processing apparatus configured to generate an image file with a structure including a first storage area configured to store a plurality of pieces of image data and a second storage area configured to store metadata relating to the plurality of pieces of image data, the metadata including specifying information for specifying a region in at least one piece of image data from among the plurality of pieces of image data, the image processing apparatus comprising:
at least one processor configured to function as following units:
an acquisition unit configured to acquire the image file for playback;
a first presentation unit configured to present any one of the plurality of pieces of image data stored in the image file for playback; and
a second presentation unit configured to present image data including a region specified by the specifying information in a case where an operation input to specify a region specified by the specifying information is detected for image data presented by the first presentation unit.

15. The image processing apparatus according to claim 1,
wherein image data stored in the first storage area is a still image and/or a moving image.

16. The image processing apparatus according to claim 1,
wherein a file format of the image file is High Efficiency Image File Format (HEIF).

17. An image capturing apparatus comprising:
the image processing apparatus according to claim 1; and
an image capture unit configured to output a plurality of pieces of image data via image capture.

18. A control method for an image processing apparatus configured to generate an image file with a structure including a first storage area configured to store a plurality of pieces of image data and a second storage area configured to store metadata relating to the plurality of pieces of image data, the metadata including first specifying information for specifying a region in a reference image data from among the plurality of pieces of image data, and second specifying information for specifying another piece of image data indicating a different representation of an object of a region specified by the first specifying information, the control method comprising:
acquiring the plurality of pieces of image data;
selecting the reference image data from the acquired plurality of pieces of image data;
setting a region for the selected reference image data;
selecting, as the another piece of image data, image data different from the reference image data from among the plurality of pieces of image data with respect to the set region; and
generating the image file storing, in the first storage area, the first specifying information configured for the set region and the second specifying information configured for the selected another piece of image data and storing, in the second storage area, the plurality of pieces of image data.

19. A control method for an image processing apparatus configured to generate an image file with a structure including a first storage area configured to store a plurality of pieces of image data and a second storage area configured to store metadata relating to the plurality of pieces of image data, the metadata including specifying information for specifying a region in at least one piece of image data from among the plurality of pieces of image data, the control method comprising:
acquiring the plurality of pieces of image data;
setting a region in the acquired plurality of pieces of image data;
selecting, from among the plurality of pieces of image data, image data indicating a most appropriate representation of an object of each set region in the plurality of pieces of image data; and
generating the image file configured for each selected piece of image data indicating the most appropriate representation and storing, in the first storage area, the specifying information for specifying a region indicating the most appropriate representation in the image data and storing, in the second storage area, the plurality of pieces of image data.

20. A control method for an image processing apparatus configured to playback an image file with a structure including a first storage area configured to store a plurality of pieces of image data and a second storage area configured to store metadata relating to the plurality of pieces of image data, the metadata including first specifying information for specifying a region in a reference image data from among the plurality of pieces of image data, and second specifying information for specifying another piece of image data indicating a different representation of an object of a region specified by the first specifying information, the control method comprising:
acquiring the image file for playback;
presenting the reference image data stored in the image file for playback; and
presenting the other piece of image data specified by the second specifying information in a case where an operation input to specify a region specified by the first specifying information is detected for the presented reference image data.

21. A control method for an image processing apparatus configured to generate an image file with a structure including a first storage area configured to store a plurality of pieces of image data and a second storage area configured to store metadata relating to the plurality of pieces of image data, the metadata including specifying information for specifying a region in at least one piece of image data from among the plurality of pieces of image data, the control method comprising:
acquiring the image file for playback;
presenting any one of the plurality of pieces of image data stored in the image file for playback; and
presenting image data including a region specified by the specifying information in a case where an operation input to specify a region specified by the specifying information is detected for the presented image data.

22. A computer-readable storage medium storing a program configured to cause a computer to function as the units of the image processing apparatus according to claim 1.
